(19) United States
(12) Patent Application Publication
(10) Pub. No.: US 2023/0340644 A1
(43) Pub. Date: Oct. 26, 2023

(54) NI-BASED ALLOY MATERIAL

(71) Applicant: NV Bekaert SA, Zwevegem (BE)

(72) Inventors: Jérémie DE BAERDEMAEKER, Anzegem (BE); Aurelie GOUX, Kain (BE)

(73) Assignee: NV Bekaert SA, Zwevegem (BE)

(21) Appl. No.: 18/021,461

(22) PCT Filed: Aug. 31, 2021
(86) PCT No.: PCT/EP2021/074008

§ 371 Date: Feb. 15, 2023

(30) Foreign Application Priority Data
Sep. 9, 2020 (EP) 20195191.0

(51) Int. Cl. C22C 19/05; C22F 1/10; C22C 1/04; C21D 8/06

(52) U.S. Cl. CPC C22C 19/055; C22F 1/10; C22C 1/0433; C21D 8/06

(57) ABSTRACT

The invention relates to a nickel-based alloy material. The nickel-based alloy material consists of in percent by weight: Chromium: 20.00 to 22.50%, Molybdenum: 11.50 to 14.50%, Iron: 2.00 to 6.00%, Copper: 2.10 to 6.00%, Tungsten: 2.50 to 3.00%, Cobalt: 2.50 max %, Carbon: 0.10 max %, Silicon: 1.00 max %, Manganese: 0.50 max %, Phosphorus: 0.02 max %, Vanadium: 0.35 max %, with a balance of nickel and impurities less than 0.02%. The invention further relates to a fiber having the above composition and a method of manufacturing such fibers.

### FIELD OF THE INVENTION

The present invention relates generally to a nickel based alloy material. The present invention specifically relates to nickel-chromium-molybdenum-copper alloys that provide a resistance to sulfuric acid and hydrochloric acid. The invention further relates to a fiber having such alloy composition and a process for manufacturing such nickel- based alloy fibers.

### BACKGROUND OF THE INVENTION

During the production and processing of semiconductors, quite some steps involve reactions with sulfuric acid and hydrochloric acid. In these reaction steps, there is a need for materials resistant to sulfuric acid and hydrochloric acid. Alloys currently considered for such applications include nickel-chromium-molybdenum having markedly excellent corrosion resistance to sulfuric acid in comparison with iron-based alloys. Hastelloy C22 and Hastelloy C276 (“Hastelloy” is a trademark), the nickel-based alloy containing 56 to 59 percent of nickel, 16 to 27 percent of chromium and 16 to 25 percent of molybdenum which are disclosed in the Patent Document JP 8-3666, EP 2479301A and so on have been used.

It is known that chromium, copper and molybdenum individually benefits the corrosion resistance of nickel-based alloys to sulfuric acid. The use of these alloying additions, however, is constrained by thermal stability considerations. In other words, if the solubilities of these elements are exceeded by a significant amount, it is difficult to avoid the precipitation of deleterious intermetallic phases in the microstructure. These can influence the manufacturing of wrought products and can impair the properties of weldments.

Wroughtable alloys with even higher resistance to sulfuric acid and hydrochloric acid are sought.

### SUMMARY OF THE INVENTION

It is an object of the present invention to provide new wroughtable alloys with higher resistance to sulfuric acid and hydrochloric acid.

It is another object of present invention to provide corrosion resistant fibers with new alloy composition and the manufacturing method thereof.

According to the present invention, it is provided a nickel-based alloy material consisting of in percent by weight: Chromium: 20.00 to 22.50%, Molybdenum: 11.50 to 14.50%, preferably Molybdenum 12.5 to 14.50%, Iron: 2.00 to 6.00%, Copper: 2.10 to 6.00%, Tungsten: 2.50 to 3.00%, Cobalt: 2.50 max %, Carbon: 0.10 max %, e.g. 0.03 max%, or 0.01 max%, Silicon: 1.00 max %, Manganese: 0.50 max %, Phosphorus: 0.02 max %, Vanadium: 0.35 max % and with a balance of nickel and impurities less than 0.02%.

The nickel-based alloy material according to the present invention can be in any form. For instance, the alloy material can be in cast form. The alloy material can be in powder metallurgy form. The alloy material can also be in fiber form. The alloy material can also be in wire, foil, or mesh form.

The current material can be manufactured in any known method for prior art available materials with similar composition. According to the invention, it is in particular provided a bundled drawing process of metal wires into fibers with the invention alloy composition.

In bundled drawing of metal fibers, a number of metal wires are bundled and drawn together. The individual wires are separated from one another by covering each metal wire, possibly even on wire rod diameter, with a suitable matrix material. All metal wires, covered with matrix material, are enveloped in an envelope material. Such an enveloped bundle of metal wires, being embedded in a matrix material is hereafter referred to as ‘composite wire’. Once the composite wire is drawn to the desired diameter, the envelope material and the matrix material are removed, usually by leaching.

According to the present invention, nickel-based alloy fibers are produced using copper or copper alloy as matrix material. A metal such as iron or copper is used as envelope material for making the fiber. The use of copper or copper alloy as matrix material is advantageous since copper or copper alloy has similar deformability properties as the nickel-based alloy wire that has to be drawn into nickel-based alloy fibers. The copper matrix is compatible with the nickel-based alloy wires during the drawing and annealing operations. The copper matrix has a lower chemical resistance and allows the nickel-based alloy fibers to be free from the matrix copper material in a leaching process quite easily.

According to the present invention, it is further provided process for the manufacturing of nickel-based alloy fibers by bundled drawing. The process according to the invention comprises the following steps: (a) providing nickel-based alloy metal wires having a composition consisting of in percent by weight : Chromium 20.00-22.50%, Molybdenum 11.50-14.50%, preferably Molybdenum 12.50-14.50%, Iron 2.00-6.00%, Tungsten 2.50-3.00%, Copper 5.00 max %, e.g. Copper 3.00 max % or Copper 1.00 max %, Cobalt 2.50 max %, Carbon 0.10 max %, e.g. 0.03 max%, or 0.01 max%, Silicon 0.08 max %, Manganese 0.50 max %, Phosphorus 0.02 max %, Vanadium: 0.35 max % and with a balance of nickel and impurities less than 0.02%; (b) embedding the nickel-based alloy metal wires in a matrix material; (c) enveloping the embedded nickel-based alloy metal wires with enveloping material to form a composite wire; (d) alternatingly subjecting said composite wire to a diameter reduction, subjecting said reduced composite wire to a heat treatment and applying a final reduction; (e) providing nickel-based alloy metal fibers by removing the matrix material and enveloping material from the composite wire. The heat treatment can be performed at a temperature in the range of 800 to 1100° C. for 0.05 to 5 minutes.

In a preferred method, the nickel-based wires are embedded in the matrix material by applying a layer of a matrix material on each of the nickel-based wires in a first step. The matrix material comprises copper or copper alloy. The thickness of this layer is for example between 1 μm and 2 mm. Possibly, the diameter of the coated wires is reduced by a drawing step. After the application of a layer of a matrix material on the individual wires and possibly after the drawing of the coated wires, the wires may be brought together to form a bundle. Subsequently, an envelope material comprising for example iron is applied around the bundle to form a composite wire.

Possibly, the method comprises a step of subjecting the composite wire to a heat treatment before reducing the diameter of the composite wire.

The reducing of the composite wire comprises the drawing of the wire by any technique known in the art. Alternatively, the reduction of the diameter may be obtained by a rolling operation.

Alternatingly, the composite wire is reduced in diameter and subjected to a heat treatment. The reductions may comprise several subsequent reduction passes, e.g. drawing operations on wire drawing machines.

The removing of the matrix material comprises preferably the leaching of the composite wire using sulfuric or nitric acid.

During each heat treatment, matrix material is diffused over a depth of the nickel-based wires, which depends largely on the temperature used during the heat treatment.

According to the present invention, the starting nickel-based alloy wire contains less copper content than that in the final nickel-based alloy fiber. It is feasible to bundle draw the nickel-based alloy wire. Intermediate heat treatments performed between two drawing steps and/or last heat treatment, result in a diffusion of copper matrix material into the nickel-based alloy wires. This has as consequence that the composition of the nickel-based alloy wire will be changed to some extent after a heat treatment.

It is known in the prior art that copper and molybdenum have good resistance to sulfuric acid but their combination would cause precipitation or sigma phase in nickel-based alloys. The sigma phase is not good for the weldability and workability. According to the present invention, the starting nickel-based alloy wire contains less copper than the final drawn fibers. Thus, the starting nickel-based alloy material does not have problems on workability. It is observed in the prior art that the sigma phases created by significant amount of copper and molybdenum is detrimental to workability. During the heat treatment of composite wire, the copper coated on the nickel-based alloy wire diffuses into the nickel-based alloy wire. An important advantage of using copper as matrix material for nickel-based alloy fiber is that the material during processing has sufficient workability and the diffusion of copper during heat treatment after wire reduction further improved the corrosion resistance of the final nickel-based alloy fiber.

According to the present invention, at least once a deformation of 4.5 or more is used to reduce the diameter of the composite wire. Deformation ε is defined as the value of the logarithmic function of the ratio of the initial cross-section S1 to the final cross-section S2 of the composite wire:

ε=ln(S1/S2)

With initial cross-section S1 is meant the cross-section of the composite wire measured after a heat treatment and before the composite wire is further drawn. With final cross-section S2 is meant the cross-section of the composite wire after deformation (drawing) without an intermediate heat treatment.

It is possible to reduce the number of annealing treatments because the nickel-based material composition allows high deformation between two annealing treatments. Preferably, such large reduction is used during the final reduction, providing a final diameter to the composite wire. Nickel-based fibers so obtained benefit most of the copper diffusion and precipitation control over its surface as subject of the invention. Heat treatment after final drawing of composite wire would increase the copper content in the nickel-based fiber but the precipitation would not affect the workability of the composite wire any more. The nickel-based alloy material according to the present invention contains sigma phase. The nickel-based alloy fiber can have sigma phase in a range of 4 to 8 vol %. It is known in the prior art, that deformability and the precipitation of sigma phases in the composite wires may negatively influence the deformability of the composite wire. In the prior art, the precipitation of sigma phase are avoided due to the deterioration of workability. Most surprisingly, it was found that the composite wires have enough workability in order to draw to small diameters although the produced fibers according to the present invention have the precipitation of sigma phase.

After final diameter reduction and before annealing treatment, the distribution of copper gradually decreases from the surface of said metal fiber to the bulk of said metal fiber. The copper content can be in a range of more than 2.1 wt % and less than 10 wt % at a depth of 100 nm below the surface of said fibers. Possibly, a heat treatment is applied after the final reduction. After this final heat treatment, it was found that the bundle of nickel-based alloy fibers have substantially equal properties over the length of the fibers and a substantially homogeneous composition. The diffusion of copper can be controlled by the annealing treatments during the drawing of the composite wire to its final diameter.

The homogeneity of the nickel-based alloy fiber according to the present invention is an important advantage, since even a small change in the surface composition of the fibers may have influences on the properties of the nickel-based alloy fibers. For example, the oxidation and corrosion resistance of nickel-based alloy fibers is dependent upon the compositional homogeneity of the nickel-based fiber surfaces.

It was found that the properties of the nickel-based alloy fibers according to the present invention are more uniform over a taken length of a nickel-based alloy fiber as subject of the invention. Such compositional homogeneity provides associated fiber properties, which are reliable and predictable, and allow a reliable and economical preventive replacement of such fibers and products comprising these nickel-based alloy fibers.

The starting nickel-based alloy wires can have a diameter between 100 μm and 20 mm. The nickel-based alloy fibers can have an equivalent diameter being more than 0.1 μm and less than 100 μm, and preferably between 0.5 and 50 μm. Equivalent diameter is defined as the diameter of an imaginary circle, of which the surface area is identical to the surface area of a cross section of the nickel-based alloy fiber.

The silicon content in the nickel-based alloy fiber can be limited to 0.08 max % since there is no contamination of silicon in the fiber processing.

Nickel-based alloy fibers according to the present invention can be used in many applications. They can for example be used in filter media, electrically conductive textiles, flocking on metal or polymer substrates.

At present, when nickel-based alloy fibers are used in filter media, in particular for the environment involving sulfuric acid and hydrochloric acid, e.g. filtration of gases in semiconductor processing, there is a need for nickel-based alloy fibers, having increased corrosion resistance. It was found that fibers as subject of the invention have improved corrosion resistance to sulfuric acid and hydrochloric acid. The average corrosion resistance rate to hydrochloric acid of the invention material is around 0.4 to 0.6 milli-inch per year (MPY). This may be contributed to the synergic effect of copper and molybdenum and the fiber production process that is beneficial for achieving such a composition.

According to another aspect of the present invention, it is provided a filter media. The invented filter media comprises at least one layer being a web of powder or fibers which has been sintered. The powder or fibers are made from a nickel-based alloy material having the composition of the invention material. It is also provided a filter system comprising a filter element with a filter media according to the present invention.

### BRIEF DESCRIPTION OF THE DRAWINGS

The invention will now be described into more detail with reference to the accompanying drawing wherein

FIG. 1 shows the corrosion resistance rate (MPY) of the nickel-based alloy fibers as subject of the invention, compared to presently known and nickel-based alloy materials having similar composition but having different copper content and/or molybdenum content.

### DESCRIPTION OF THE PREFERRED EMBODIMENTS OF THE INVENTION

Table 1 gives the composition of nickel-based alloy fibers sample A and sample B according to the present invention, and a nickel-based alloy sample material X.

Nickel-based alloy fibers as subject of the invention may be provided by using following preferred process. Nickel-based wires of diameter between 0.5 and 1.5 mm, e.g. 1.4 mm and having a composition according to example X of nickel-based alloy material X in table 1 are provided. These nickel-based alloy wires are coated by e.g. electrolytic coating with a layer of copper or copper alloy. Preferably, this layer ranges from 3 to 100 μm, e.g. 5 μm thickness. Usually, 50 to 2000 nickel-based alloy wires are bundled into a composite wire. After reduction of the diameter of the composite wire, and removing of the enveloping and matrix material, an obtained bundle of nickel-based alloy fibers as subject of the invention comprises 50 to 2000 nickel-based alloy fibers. Most preferably 90 to 1000 nickel-based alloy wires are bundled. Possibly the coated nickel-based wires are reduced to a diameter ranging from 0.1 to 1 mm, e.g. 0.35 mm. Several coated wires, e.g. 1000, possibly reduced in diameter, are enveloped in an e.g. iron envelope, so providing a composite wire having a diameter in the range of 5 to 15 mm.

TABLE 1
the composition (in wt %) of nickel-based alloy fibers
sample A and sample B according to the present invention,
and a nickel-based alloy sample material X.

| | | | Nickel-based | Nickel-based |
|---|---|---|---|---|
| | | Nickel-based | alloy fiber | alloy fiber |
| | | alloy sample | composition | composition |
| | | material X | sample A | sample B |
| Content | Chromium | 20.00-22.50 | 21.20 | 21.48 |
| (wt %) | Molybdenum | 12.50-14.50 | 13.07 | 12.39 |
| | Iron | 2.00-6.00 | 4.46 | 4.35 |
| | Copper | 0.50 max | 2.49 | 3.14 |
| | Tungsten | 2.50-3.00 | 2.75 | 2.69 |
| | Cobalt | 2.50 max | 2.50 max | 2.50 max |
| | Carbon | 0.10 max | 0.10 max | 0.10 max |
| | Silicon | 1.00 max | 1.00 max | 1.00 max |
| | Manganese | 0.50 max | 0.50 max | 0.50 max |
| | Phosphorus | 0.02 max | 0.02 max | 0.02 max |
| | Vanadium | 0.35 max | 0.35 max | 0.35 max |
| | Nickel | Balanced | Balanced | Balanced |
| Average | | 1.3 | 0.4 | 0.6 |
| corrosion | | | | |
| rate (MPY) | | | | |

This composite wire is alternatingly reduced with several reduction rates ε (e.g. ε1, ε2) higher than 0.5, e.g. 1.5 and then annealed at a temperature in the range of 800 to 1100° C., e.g. 1030° C. This heat treatment takes 0.05 to 5 minutes, e.g. 2 minutes. A final reduction reduces the composite diameter with ε being higher than 4.5. This final reduction provides the final diameter to the composite wire. Finally, the matrix and enveloping material is removed by pickling with an acid, e.g. nitric acid. Nickel-based alloy fibers with a diameter in the range of e.g. 0.5 to 5 μm are obtained, which have copper diffusion over the nickel-based alloy fibers.

It was found that sigma phases are homogeneously distributed in the composite wire. The composition of these sigma phases are different from the matrix of nickel-base alloy fibers. In general, the sigma phase have more molybdenum and tungsten than in the matrix of nickel-base alloy fiber. Sigma phase may contain more than 20 wt % molybdenum, e.g. from 25 to 40 wt %, and more than 5 wt % tungsten, e.g. 6 to 8 wt %. Examples of the composition of sigma phase are listed below in table 2. The sigma phase in the material of the present invention particularly contains copper content, e.g. 1 to 3 wt % or 1 to 2 wt %, while in the rest bulk of nickel-based alloy fibers (herein, the rest bulk refers to bulk areas except sigma phases), the copper content is in a range of 3 to 7 wt %, e.g. 3 to 5 wt %. The copper content in the sigma phase is less than the rest bulk of the nickel-based alloy material. The sigma phase is homogeneously distributed in nickel-based alloy fibers. This distinguishes the present invention material from the existing nickel-based alloy sample material X (table 1) and another referenced Nickel-based alloy foil with similar composition of material X. As shown in table 2, the referenced material have no copper content in their sigma phase.

TABLE 2
Examples of the composition of sigma phase (in wt %)
measured by Energy-dispersive X-ray spectroscopy.

| Spectrum | Cr | Fe | Ni | Cu | Mo | W |
|---|---|---|---|---|---|---|
| Invention Sample 1 | 19.8 | 4.6 | 41.4 | 1.9 | 26.2 | 6.1 |
| Invention sample 2 | 18.1 | 4.1 | 35.4 | 1.6 | 33.7 | 7.3 |
| Invention sample 3 | 16.2 | 3.1 | 37.7 | 2.0 | 34.1 | 7.0 |
| Nickel-based alloy | 14.6 | 2.7 | 32.2 | 0 | 39.4 | 9 |
| sample material X | | | | | | |
| Nickel-based alloy | 22.9 | 1.5 | 41.4 | 0 | 29.0 | 5.1 |
| referenced foil | | | | | | |

In one embodiment, fibers having the composition of the invention were drawn to a final diameter of 8 μm and the sigma phases therein are found around 7 vol %. As another example, invention nickel-based alloy fibers were drawn to 1.5 μm and contain 5.5 vol % sigma phase.

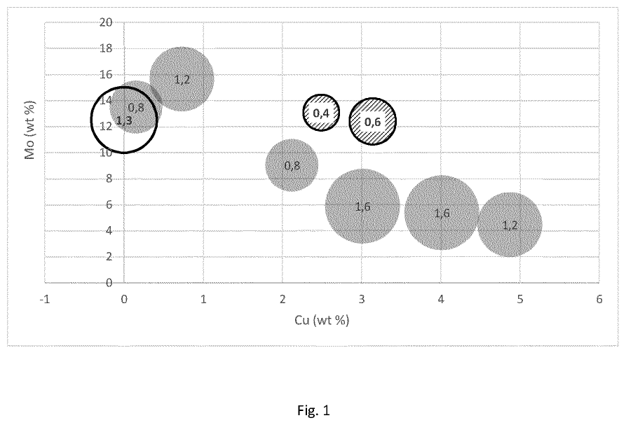

The nickel-based alloy fibers as subject of the invention have improved corrosion resistance to hydrochloric acid, as compared to similar presently known nickel-based alloy material. In FIG. 1, examples of corrosion resistance rate to hydrochloric acid, measured on nickel-based alloy fibers as subject of the invention (sample A and B), and on presently known nickel-based alloy material with similar composition, derivable from patent EP2479301 are provided.

The referenced material as listed in FIG. 1 have similar composition to the invention material except the different copper and/or molybdenum contents. In FIG. 1, the copper content of the material is indicated in horizontal axis and the molybdenum content is indicated in vertical axis. The bubbles in FIG. 1 indicates the corrosion resistance rate to hydrochloric acid of individual material.

The nickel-based alloy fiber sample A according to the invention has a corrosion resistance rate to hydrochloric acid of 0.4 MPY while sample B of the invention has a corrosion resistance rate to hydrochloric acid of 0.6 MPY. Sample X of reference material as in table 1 has a corrosion resistance rate to hydrochloric acid of 1.3 MPY. As shown in FIG. 1, other referenced material with similar composition but with either low copper content or low molybdenum content all have higher corrosion resistance rate than the invention nickel-based alloy fibers.

1. A nickel-based alloy material, consisting of in percent by weight:
Chromium: 20.00 to 22.50%
Molybdenum: 11.50 to 14.50%
Iron: 2.00 to 6.00%
Copper: 2.10 to 6.00%
Tungsten: 2.50 to 3.00%
Cobalt: 2.50 max
Carbon: 0.10 max %
Silicon: 1.00 max %
Manganese: 0.50 max
Phosphorus: 0.02 max
Vanadium: 0.35 max
with a balance of nickel and impurities less than 0.02%.

2. The nickel-based alloy material according to claim 1, wherein said nickel-based alloy material contains sigma phase.

3. The nickel-based alloy material according to claim 2, wherein said sigma phase is in a range of 4-8 vol %.

4. The nickel-based alloy material according to claim 1, wherein the alloy material is in cast form.

5. The nickel-based alloy material according to claim 1, wherein the alloy material is in powder metallurgy form.

6. The nickel-based alloy material according to claim 1, wherein the alloy material is in fiber form.

7. The nickel-based alloy material according to claim 6, wherein said nickel-based alloy fiber having an equivalent diameter being more than 0.1 μm and less than 100 μm.

8. The nickel-based alloy material according to claim 7, whereby said nickel-based alloy fiber has a silicon content of 0.08 max %.

9. The nickel-based alloy material according to claim 7, whereby the distribution of copper gradually decreases from the surface of said nickel-based alloy fiber to the bulk of said nickel-based alloy fiber, whereby the copper content is in a range of more than 2.1 wt % and less than 10 wt % at a depth of 100 nm below the surface of said fibers.

10. The nickel-based alloy material according to claim 2, the copper content in the sigma phase is less than the rest bulk of the nickel-based alloy material.

11. A filter media, said filter media comprising at least one layer, said layer being a web of powder or fibers which has been sintered, said powder or fibers being made from a nickel-based alloy material as in claim 6.

12. A filter system comprising a filter element with a filter media as in claim 11.

13. A method for the manufacturing of nickel-based alloy fibers by bundled drawing, said process comprising the steps of :
a. providing nickel-based alloy metal wires having a composition consisting of in percent by weight :
Chromium: 20.00-22.50%
Molybdenum: 11.50-14.50%
Iron: 2.00-6.00%
Tungsten: 2.50-3.00%
Copper: 5.00 max
Cobalt: 2.50 max
Carbon: 0.10 max %
Silicon: 0.08 max
Manganese: 0.50 max
Phosphorus: 0.02 max
Vanadium: 0.35 max
with a balance of nickel and impurities less than 0.02%;
b. embedding the nickel-based alloy metal wires in copper or copper alloy as a matrix material;
c. enveloping the embedded nickel-based alloy metal wires with enveloping material to form a composite wire;
d. alternatingly subjecting said composite wire to a diameter reduction, subjecting said reduced composite wire to a heat treatment at a temperature in the range of 800 to 1100° C. for 0.05 to 5 minutes, and applying a final reduction;
e. providing nickel-based alloy fibers by removing the matrix material and enveloping material from the composite wire.

14. The method according to claim 13, whereby said process comprises a heat treatment after said final reduction.
